(19) United States
(12) Patent Application Publication
(10) Pub. No.: US 2026/0368348 A1
(43) Pub. Date: Nov. 19, 2026

(54) ADVANCED GROUNDING DATA CONTROL FOR LARGE LANGUAGE MODELS

(71) Applicant: Microsoft Technology Licensing, LLC, Redmond, WA (US)

(72) Inventors: Nikita BANDYOPADHYAY, Bellevue, WA (US); Craig Joseph Santo, Redmond, WA (US); Kristofer D. Hoffman, Sammamish, WA (US); Sanjoyan Mustafi, Redmond, WA (US); Neetha Sumana Tuluri, Sammamish, WA (US); Amit Kumar Pathak, Hyderabad (IN); Connie Yujia Lin, Long Island City, NY (US); Kunpeng Zhu, Bellevue, WA (US); Ankush Grover, Hyderabad (IN); Jayant Kishorbhai Manglani, Redmond, WA (US)

(21) Appl. No.: 19/212,371

(22) Filed: May 19, 2025

(51) Int. Cl. G06F 21/62; G06F 16/14

(52) U.S. Cl. CPC G06F 21/6227; G06F 16/148

(57) ABSTRACT

Example methods, apparatuses, and computer-readable media provide an enterprise data management system configured to protect a site during a search. The system is configured to obtain a designation of a property associated with a site as protected from organization wide searches, the site being owned by an organization and including multiple files, the property being separate from a user access permission. The system receives a search request indicating an organization wide search from an artificial intelligence agent. The system performs a search according to the search request across an index of organization files. The system trims search results to exclude files within one or more sites having the property. The system returns the trimmed search results to the artificial intelligence agent.

### TECHNICAL FIELD

The present disclosure relates to advanced grounding data control for large language models.

### BACKGROUND

Generative artificial intelligence (AI) has rapidly advanced and has shown promise in providing interactions between human users and computer systems. For example, chat bots are a form of generative AI that uses a large language model (LLM) to respond to prompts from a user. Such chat bots have been incorporated into various customer facing applications to provide services such as searching, instructions, troubleshooting, and navigation.

Chat bots conventionally use an LLM to produce textual responses. In order for an LLM to provide more relevant answers, an LLM may be provided with grounding data that may be relevant to a specific domain. Enterprise data stored in a shared repository may appear to be an abundant source of grounding data for an LLM to provide relevant answers about an enterprise. However, enterprises are concerned with LLMs or AI more generally having access to information, or at least certain types of information.

Accordingly, there is a need for improvements to data management systems to allow access to enterprise data as grounding data, while also allowing enterprises to broadly exclude data from LLMs.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a computing system including: a memory storing computer-executable instructions; and one or more processors, individually or in combination, configured to execute the instructions, wherein the one or more processors are configured to: obtain a designation of a property associated with a site as protected from organization wide searches, the site being owned by an organization and including multiple files, the property being separate from a user access permission; receive a search request indicating an organization wide search from an artificial intelligence agent; perform a search according to the search request across an index of organization files; trim search results to exclude files within one or more sites having the property; and return the trimmed search results to the artificial intelligence agent.

In some aspects, the techniques described herein relate to a method of protecting content during a search: obtain a designation of a property associated with a site as protected from organization wide searches, the site being owned by an organization and including multiple files, the property being separate from a user access permission; receiving a search request indicating an organization wide search from an artificial intelligence agent; performing a search according to the search request across an index of organization files; trimming search results to exclude files within one or more sites having the property; and returning the trimmed search results to the artificial intelligence agent.

In some aspects, the techniques described herein relate to a non-transitory computer-readable medium storing computer-executable instructions, that when executed cause a processor to: obtain a designation of a property associated with a site as protected from organization wide searches, the site being owned by an organization and including multiple files, the property being separate from a user access permission; receive a search request indicating an organization wide search from an artificial intelligence agent on behalf of a user; perform a search according to the search request across an index of organization files; trim search results to exclude files within one or more sites having the property; return the trimmed search results to the artificial intelligence agent; and allow the user having the user access permission to access the site including the excluded files outside of the organization wide search.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a conceptual diagram of an example of an architecture for an enterprise data management system to provide users with access to enterprise files stored within a cloud network, in accordance with aspects described herein.

FIG. 2 is a logical flow diagram illustrating an example process that may be used to trim search results based on the property and a type of search, in accordance with aspects described herein.

FIG. 3 is a schematic diagram of an example of an apparatus (e.g., a computing device) for controlling searches to protect sites, in accordance with aspects described herein.

FIG. 4 illustrates an example of a user device, in accordance with aspects described herein.

FIG. 5 is a flow diagram of an example of a method for controlling a search, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to data management, particularly in the context of enterprise data management where generative AI may access enterprise data as grounding data. For example, a generative AI service may interact with a client such as a user device. For example, the generative AI service may provide answers to queries submitted by a user. Generative AI may refer to various models that are trained to generate content in response to a prompt. A generative AI model is trained on a corpus of works and the model generates a similar work based on the prompt. For example, Large Language Model (LLM) is a term that refers to artificial intelligence or machine-learning models that can generate natural language texts from large amounts of data. Large language models use deep neural networks, such as transformers, to learn from billions or trillions of words, and to produce texts on any topic or domain. LLMs can also perform various natural language tasks, such as classification, summarization, translation, generation, and dialogue. A small language model may be similar to an LLM, but trained or pruned to focus on a particular task or domain. Accordingly, a small language model may produce similar results to an LLM using fewer computing resources. The term language model is used to refer to either an LLM or small language model. Additionally, generative AI models include text-to-image and text-to-video AI models. Further, generative AI models may include multi-modal models that receive different types of input such as text, audio, images, and/or video. As used herein, the term “prompt” refers to any input into a generative AI model without being limited to a particular modality.

Although generative AI has proved useful in many contexts, there are several known issues with generative AI. One issue is the concept of a hallucination, where a generative AI may generate a response that has no factual support. One cause of hallucinations is a time gap between training and inference. The corpus used to train models, especially LLMs, has a cut-off date because of the large costs of training the model. Accordingly, a generative AI often has difficulty answering prompts related to information after the cut-off date and may hallucinate to provide a response. As another example, relevant information for answering a prompt may be in a private domain that is not included in the corpus.

One approach to addressing weaknesses of LLMs is to provide grounding data that is relevant to a specific domain for the prompt. For example, in the context of an enterprise such as a government or business, the enterprise may store a large number of computer files that contain information about the enterprise. An AI agent based on an LLM is more likely to provide a correct response to a prompt about the enterprise if provided with relevant enterprise files.

Conventional approaches to enterprise data management may not fully address privacy and security concerns associated with AI agent access to enterprise data. For instance, access control systems are designed to allow specific users or groups of to perform various operations (e.g., read, write, edit) on computer files. Permissions can be assigned to users based on role and level of trust. In the case of an AI agent, there is uncertainty regarding the scope of permissions that should be allowed and whether an AI agent can be trusted. For example, many view an AI agent or LLM as a block box where handling of data is uncertain. For instance, there is concern that an AI agent may retain some level of information in internal weights or embeddings, then later reconstruct that information when prompted. However, in order to provide relevant information to a user, the AI agent may need a similar level of access to the enterprise data as the user.

In an aspect, the present disclosure provides advanced grounding data control for large language models in the context of an enterprise data management system. The enterprise data management system may store vast amounts of data in the form of computer files that are accessible to enterprise users via network connections. For instance, enterprise data management systems can store millions, billions, or trillions of computer files. The computer files may be organized into sites having different administrators. Additionally, each file may be associated with access control permissions that govern how users interact with a file. The present disclosure addresses the issue of AI agents at the search level by allowing an administrative user the ability to designate a site as protected from organization wide searches. The property is applicable to all files within the site. When a search request is received, the enterprise data management system performs the search and obtains search results that may include files from sites designated as protected. The enterprise data management system then trims the search results for one or more sites having the property set before returning the trimmed search results that exclude files from the sites with the property set. For instance, in order to ingest relevant grounding data, an AI agent must first search for the relevant files. By providing an additional layer of content control during a search, the present disclosure provides site administrators an effective mechanism for limiting access to AI agents. More generally, the techniques disclosed limit organization wide searches while still allowing users to find restricted files using narrower site searches and direct access to files.

Implementations of the present disclosure may realize one or more of the following technical effects. Firstly, designation of a site level property used to filter search results. provides an easy configuration of file access against AI use of certain domain specific information. That is, a site administrator is able to conveniently limit AI and search access to a site with a single property rather than having to adjust user permissions. Secondly, in some implementations, the site level property is propagated to a search index such that filtering can be applied at the search entity without need to access the original file or access control permissions.

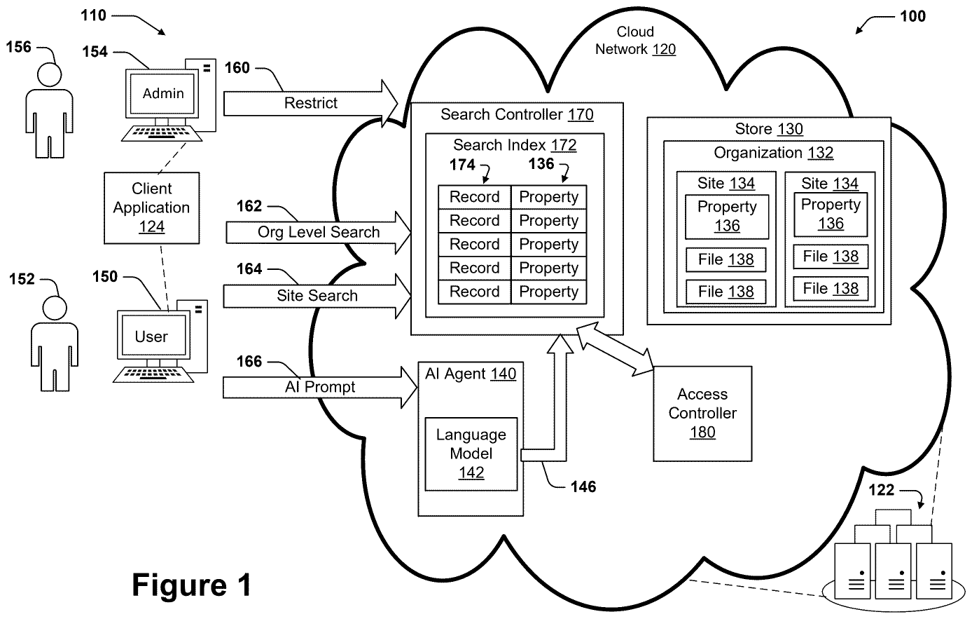

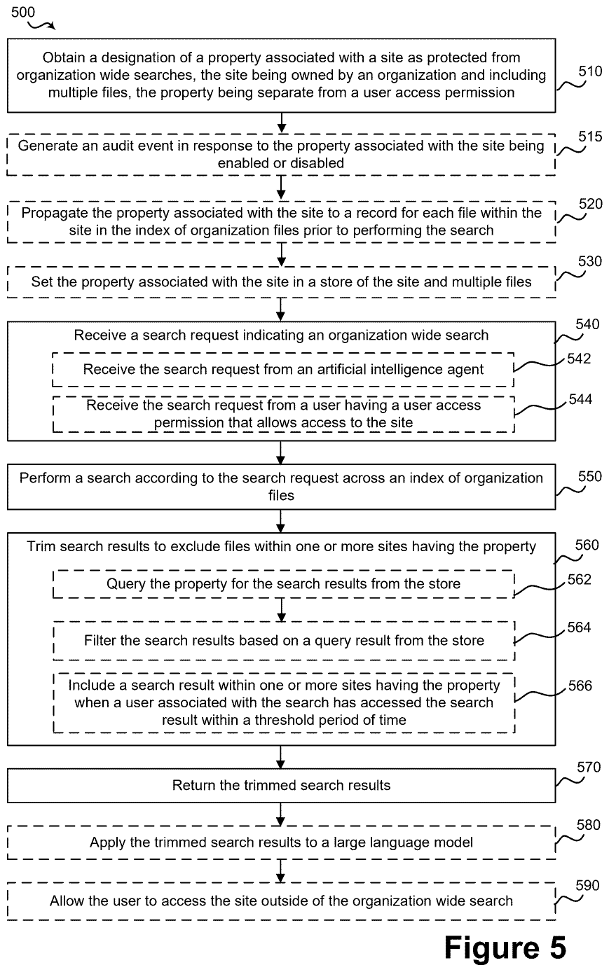

Turning now to FIGS. 1-5, examples are depicted with reference to one or more components and one or more methods that may perform the actions or operations described herein, where components and/or actions/operations in dashed line may be optional. Although the operations described below in FIG. 5 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a conceptual diagram 100 of an example of an architecture for an enterprise data management system 110 to provide users with access to enterprise files stored within a cloud network 120. The enterprise data management system 110 can provide direct access to files as well as searches including organization wide searches and site specific searches. Additionally, the enterprise data management system 110 may include an artificial intelligence (AI) agent 140 that can access files on behalf of a user.

The enterprise data management system 110 can be implemented on the cloud network 120, which includes computing resources that are controlled by a network operator and accessible to public clients such as a user device 150 operated by a user 152 and an administrative device 154 operated by an administrator 156. For example, the cloud network 120 may include one or more datacenters 122 that include computing resources such as computer memory and processors. In some implementations, the datacenters 122 may host a compute service that provides computing nodes on computing resources located in the datacenter. The computing nodes may be containerized execution environments with allocated computing resources. For example, the computing nodes may be virtual machines (VMs), process-isolated containers, or kernel-isolated containers. The nodes may be instantiated at a datacenter 122 and imaged with software (e.g., operating system and applications for a service). The cloud network 120 may include edge routers that connect the datacenters 122 to external networks such as internet service providers (ISPs) or other autonomous systems (ASes) that form the Internet.

The enterprise data management system 110 includes a store 130 configured to retain computer files 138. For example, the store 130 may be implemented on data storage devices within the datacenters 122. The store 130 provides separate storage for an organization 132, which may also be referred to as a tenant. The organization 132 has control over all of the computer files in the store 130 and can set policies and access control permissions. The organization 132 may partition files into sites 134. For example, departments or groups within an organization 132 may be associated with a site 134. The site administrator 156 may have control over the access control permissions within an associated site.

A user 152 may access files 138 via the user device 150. For instance, a user 152 may transmit an organization level search request 162, a site search request 164, or send an AI prompt 166. The user 152 may also directly request a file or access a previously accessed file. When a user requests a search, a search controller 170 uses a search index 172 to locate records 174 (i.e., corresponding to files 138) that match the search criteria. For instance, the search index 172 may be a lexical search index that matches key words within the search criteria or a semantic search index that matches context of the search criteria, for example, using semantic embeddings. In some implementations, the search controller 170 uses both a lexical search index and a semantic search index. The search controller 170 produces a set of search results. Conventionally, an access controller 180 can apply access control permissions for the individual files to the search results prior to returning the search results to the user device 150. Accordingly, the user 152 can only view search results that the user has permission to access.

An AI prompt 166 may operate in a similar manner to a search. An AI agent 140 receives the AI prompt 166 provided by the user 152. The AI agent 140 may be referred to as an AI assistant, Co-Pilot, or other name. The AI agent 140 is a generative AI tool and may include an interface (e.g., basic text-based interface such as a chat interface). The AI agent 140 includes a language model 142 that analyzes the AI prompt 166 and generates a plan to respond to the prompt. The plan can include a query to obtain grounding data. The language model 142 can generate a search request 146 that follows the same procedures as an organization level search request 162. The search request 146 may inherit the same file access permissions as the user 152. Accordingly, the search controller 170 may perform the search and provide the relevant search results to the AI agent that the user would be able to access.

An AI agent 140, however, raises concerns for security and privacy in comparison to a human user. For example, the AI agent 140 is capable of consuming a much larger quantity of data than a human user. The AI agent may process the search results as grounding data and generate derivative files or data structures. Due to the complexity of the language model 142, there is uncertainty as to how exactly the grounding data is being used. Accordingly, there is a desire of organizations to further protect certain files and types of data such that an AI agent 140 cannot include the files in grounding data.

In an aspect, the present disclosure provides a property 136 that is associated with a site 134. The property 136 indicates that organization wide searches are restricted for the site 134 and files within the site 134. The property 136 may be set by a site administrator 156. For example, the site administrator 156 may issue a restrict command 160 that sets the property 136 for the site 134. Setting the property allows a search controller 170 to exclude files within the site 134 from search results, even if the user has permission to access the file. For example, the search controller 170 may trim search results based on the property to exclude files 138 that are associated with a site 134 having the property 136 set. Accordingly, a user 152 conducting an organization level search request 162 may not receive search results from sites that are protected by the property 136. Similarly, the AI agent 140 will not receive the search results that are protected by the property 136. The user 152 may still obtain access to files for which the user has the correct permissions by performing a narrower site search request 164 or directly accessing the file. In some implementations, the user search results may also include a file from a protected site when the user has recently accessed the file, for instance, when the file is in a working set associated with the user.

In some implementations, the property 136 is propagated to record 174 within the search index 172 that is associated with a respective file within the site 134. The property 136 being associated with the search index 172 simplifies the trimming procedure by giving the search controller direct access to the property 136. However, since the property 136 is set for a site while the search index 172 has information for individual files 138, there is a possibility of a mismatch between the property 136 of the site 134 in the store and the property 136 in the search index. In particular, the process of propagating the property 136 to the search index may take significant time and processor cycles, particularly when the property 136 is changed for a large site or multiple sites. In some implementations, an audit event may be generated in response to the property 136 associated with the site being enabled or disabled (e.g., by the restrict command 160). The audit events may be used to monitor how quickly the property 136 is propagated within the search index 172.

In other implementations, the store 130 may determine whether the property 136 is set for each search result. The search controller 170 may query the store 130 with the search results to determine the status of the property 136 for each search result. The query to the store 130 may provide the current status of the property 136 without delays associated with propagation. The query to the store 130, however, may increase system complexity and incur a minor delay is search time. In some implementations, both the search index and 172 and the store 130 may be checked, for example, when there is record of recent audit events or an AI agent 140 is generating the search request 146.

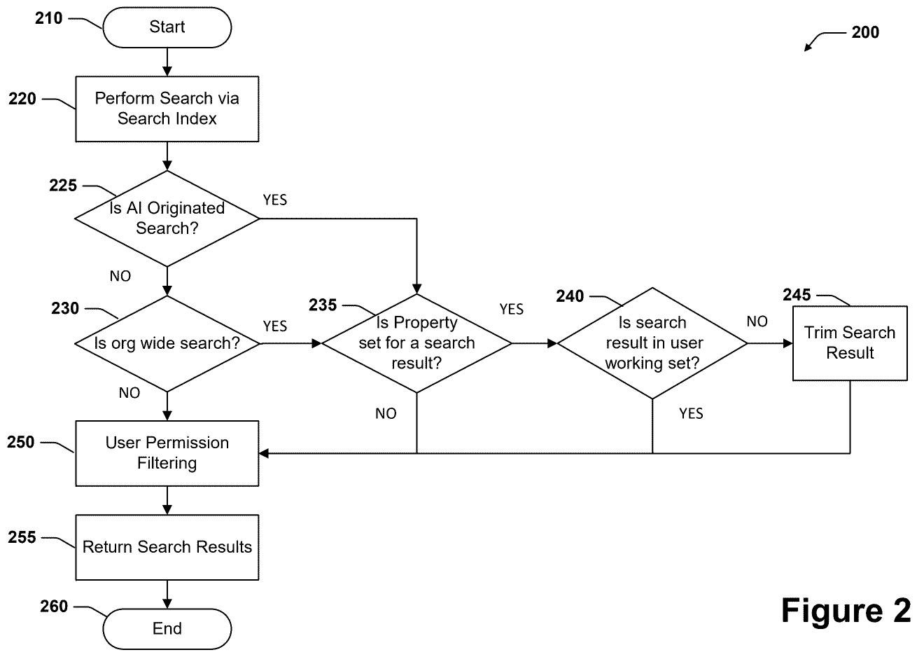

FIG. 2 is a logical flow diagram illustrating an example process 200 that may be used to trim search results based on the property 136 and a type of search. For example, the logic may be implemented by the search controller 170, which may communicate with the user 152, the AI agent 140, and/or the store 130.

A process may start at block 210 and proceed to block 220, where the search controller 170 performs a search via the search index 172. The search produces a set of search results including files 138. Each file is associated with one or more sites 134 within the store 130, and each site 134 is associated with the property 136, which may be set as enabled or disabled.

At block 225, the search controller 170 may determine whether the search is an AI originated search. If the search is an AI originated search, the process 200 may proceed to block 235. If the search is not an AI originated search, the process 200 may proceed to block 230.

At block 230, the search controller 170 may determine whether the search is an organization wide search. If the search is an organization wide search, the process 200 may proceed to block 235. If the search is not an organization wide search, the process 200 may proceed to block 250.

At block 235, in the case of an AI originated search or an organization wide search, the search controller 170 may determine whether the property 136 is set for each search result. For each search result, if the property 136 is set (i.e., enabled), the process 200 may proceed to block 240 for that search result. If the property 136 is not set (i.e., disabled), the process 200 may proceed to block 250.

At block 240, the search controller 170 may determine whether the search result is in the user working set. The working set for a user refers to files that the user has recently accessed. For example, the working set may include files that the user has accessed within a threshold period of time. In some implementations, the threshold may be specific for a file or may be based on how many times the user has accessed the file. For instance, a file that has only been accessed once may be associated with a shorter threshold than a file that has been accessed multiple times by the user. In some implementations, the files that are in the working set may be referred to as recent files and may be accessible via a link on the user device 150. If the search result is in the user working set, the process proceeds to block 250 (i.e., without trimming the result). If the search result is in the working set, the process 200 proceeds to block 245.

At block 245, the search controller 170 trims the search result. That is, the search controller removes the search result corresponding to the site having the property 136 enabled. The process proceeds to block 250. At block 250, the search controller 170 and/or the access controller 180 can further filter the search results based on user permissions. In some implementations, the block 250 may occur after the block 220 (i.e., the user permissions may be checked before the property 136).

At block 255, the search controller 170 returns the search results to the user 152 and/or the AI agent 140. The search results may include information about the relevant files 138 such as a name, date, metadata, or summary. The search results may identify a file location or provide a link for the user 152 and/or the AI agent 140 to retrieve one or more files 138 from the store 130. The user 152 and/or the AI agent 140 may access the files 138 as needed. For example, the AI agent 140 may apply a file 138 to the language model 142 to ingest as grounding data. The process 200 ends at block 260.

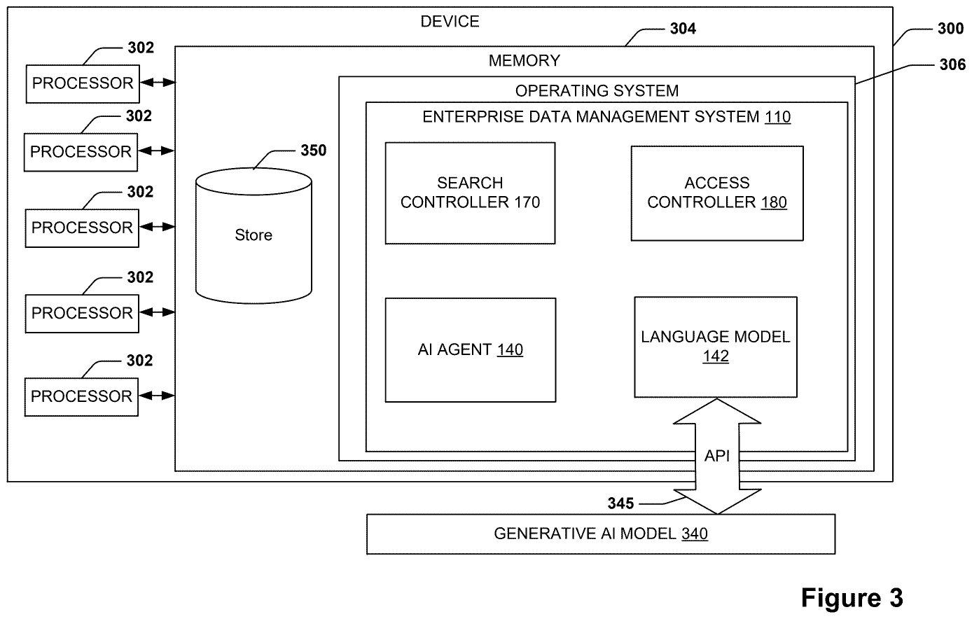

FIG. 3 is a schematic diagram of an example of an apparatus 300 (e.g., a computing device) for controlling searches to protect sites. The apparatus 300 may be implemented as one or more computing devices in the cloud network 120.

In an example, the apparatus 300 includes at least one processor 302 and at least one memory 304 configured to execute or store instructions or other parameters related to providing an operating system 306, which can execute one or more applications or processes, such as, but not limited to, the AI agent 140, the search controller 170, and/or the access controller 180. For example, processors 302 and memory 304 may be separate components communicatively coupled by a bus (e.g., on a motherboard or other portion of a computing device, on an integrated circuit, such as a system on a chip (SoC), etc.), components integrated within one another (e.g., a processor 302 can include the memory 304 as an on-board component), and/or the like. Memory 304 may store instructions, parameters, data structures, etc. for use/execution by processor 302 to perform functions described herein. In some implementations, the memory 304 includes a storage device 350, which may implement the store 130. That is, the files 138 may be stored on the storage device 350. In some implementations, the apparatus 300 includes a generative AI model 340, which may include the language model 142. Alternatively, the generative AI model 340 may be executed on a different device that may be accessed via an API 345.

In an example, the operating system 306 controls execution of the search controller 170, access controller 180, and AI agent 140.

In some implementations, the apparatus 300 is implemented as a distributed processing system, for example, with multiple processors 302 and memories 304 distributed across physical systems such as servers, virtual machines, or datacenters 122. For example, one or more of the components of the enterprise data management system 110 may be implemented as services executing at different datacenters 122. The services may communicate via an API.

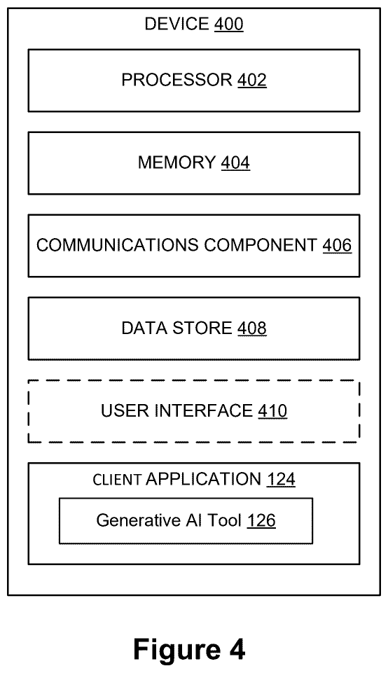

FIG. 4 illustrates an example of a user device 400. The user device 400 may be an example of the user device 150 or the administrative device 154. In one aspect, device 400 includes processor 402, which may be similar to processor 302 for carrying out processing functions associated with one or more of components and functions described herein. Processor 402 can include a single or multiple set of processors or multi-core processors. Moreover, processor 402 can be implemented as an integrated processing system and/or a distributed processing system.

Device 400 further includes memory 404, which may be similar to memory 304 such as for storing local versions of operating systems (or components thereof) and/or applications being executed by processor 402, such as a client application 124 including a generative AI tool 126 for accessing the AI agent 140. Memory 404 can include a type of memory usable by a computer, such as random access memory (RAM), read only memory (ROM), tapes, magnetic discs, optical discs, volatile memory, non-volatile memory, and any combination thereof. The processor 402 may execute instructions stored on the memory 404 to cause the device 400 to perform the methods discussed below with respect to FIG. 5.

Further, device 400 includes a communications component 406 that provides for establishing and maintaining communications with one or more other devices, parties, entities, etc. utilizing hardware, software, and services as described herein. Communications component 406 carries communications between components on device 400, as well as between device 400 and external devices, such as devices located across a communications network and/or devices serially or locally connected to device 400. For example, communications component 406 may include one or more buses, and may further include transmit chain components and receive chain components associated with a wireless or wired transmitter and receiver, respectively, operable for interfacing with external devices.

Additionally, device 400 may include a data store 408, which can be any suitable combination of hardware and/or software, that provides for mass storage of information, databases, and programs employed in connection with aspects described herein. For example, data store 408 may be or may include a data repository for operating systems (or components thereof), applications, related parameters, etc. not currently being executed by processor 402. In addition, data store 408 may be a data repository for the client application 124.

Device 400 may optionally include a user interface component 410 operable to receive inputs from a user of device 400 and further operable to generate outputs for presentation to the user. One or more input devices may control the device 400 via the user interface component 410. Example input devices, may include but are not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, the device 400 may output data or signals via user interface component 410 to one or more output devices, including but not limited to a display, a speaker, a haptic feedback mechanism, a printer, any other mechanism capable of presenting an output to a user, or any combination thereof.

Device 400 additionally includes the client application 124 including a generative AI tool for providing generative AI assistance to a user of the client application 124.

FIG. 5 is a flow diagram of an example of a method 500 for controlling a search. For example, the method 500 can be performed by the system 110, the apparatus 300 and/or one or more components thereof to answer organization level search request 162 or AI prompt 166 from a client (e.g., user device 150).

At block 510, the method 500 includes obtaining a designation of a property associated with a site as protected from organization wide searches, the site being owned by an organization and including multiple files, the property being separate from a user access permission. For example, in an aspect, apparatus 300, processor 302, memory 304, and/or search controller 170 may be configured to or may comprise means for obtaining a designation of a property 136 associated with a site 134 as protected from organization wide searches. The site 134 is owned by an organization 132 and includes multiple files 138. The property 136 is separate from a user access permission. For example, the search controller 170 may receive the command 160 from the administrator 156 as the designation of the property 136.

At block 515, the method 500 may optionally include generating an audit event in response to the property associated with the site being enabled or disabled. For example, in an aspect, apparatus 300, processor 302, memory 304, and/or search controller 170 may be configured to or may comprise means for generating an audit event in response to the property 136 associated with the site 134 being enabled or disabled.

At block 520, the method 500 may optionally include propagating the property associated with the site to a record for each file within the site in the index of organization files prior to performing the search. For example, in an aspect, apparatus 300, processor 302, memory 304, and/or search controller 170 may be configured to or may comprise means for propagating the property 136 associated with the site 134 to a record 174 for each file 138 within the site in the index 172 of organization files prior to performing the search.

At block 530, the method 500 may optionally include setting the property associated with the site in a store of the site and multiple files. For example, in an aspect, apparatus 300, processor 302, memory 304, and/or the store 130 may be configured to or may comprise means for setting the property 136 associated with the site 134 in the store 130 of the site 134 and multiple files 138.

At block 540, the method 500 includes receiving a search request indicating an organization wide search. For example, in an aspect, apparatus 300, processor 302, memory 304, and/or the search controller 170 may be configured to or may comprise means for receiving a search request 162 (or 180) indicating an organization wide search. The block 540 may optionally include, at sub-block 542, receive the search request 146 from an artificial intelligence agent 140. The block 540 may optionally include, at sub-block 544, receiving the search request 162 from a user 152 having a user access permission that allows access to the site 134.

At block 550, the method 500 includes performing a search according to the search request across an index of organization files. For example, in an aspect, apparatus 300, processor 302, memory 304, and/or the search controller 170 may be configured to or may comprise means for performing the search according to the search request 162 across the search index 172 of organization files 138.

At block 560, the method 500 includes trimming search results to exclude files within one or more sites having the property. For example, in an aspect, apparatus 300, processor 302, memory 304, and/or the search controller 170 may be configured to or may comprise means for trimming search results to exclude files 138 within one or more sites 134 having the property 136 (i.e., set to enabled). The block 560 may optionally include, at sub-block 562, querying the property 136 for the search results from the store 130. For example, the sub-block 542 may be executed in implementations where the block 530 is executed. The block 560 may optionally include, at sub-block 564, filtering the search results based on a query result from the store 130. For example, the sub-block 564 may be executed after the sub-block 562. The block 560 may optionally include, at sub-block 566, including a search result within one or more sites 134 having the property 136 when a user 152 associated with the search has accessed the search result within a threshold period of time.

At block 570, the method 500 includes returning the trimmed search results. For example, in an aspect, apparatus 300, processor 302, memory 304, and/or the search controller 170 may be configured to or may comprise means for returning the trimmed search results. For instance, the search controller 170 may return the trimmed search results to the AI agent 140 or to the user 152.

At block 580, the method 500 may optionally include applying the trimmed search results to a large language model. For example, in an aspect, apparatus 300, processor 302, memory 304, and/or the search controller 170 may be configured to or may comprise means for applying the trimmed search results to a large language model 142.

At block 590, the method 500 may optionally include allowing the user to access the site outside of the organization wide search. For example, in an aspect, apparatus 300, processor 302, memory 304, and/or the access controller 180 may be configured to or may comprise means for allowing the user 152 to access the site 134 outside of the organization wide search request 162. For example, the user 152 may transmit a site search request 164 or directly request a file 138 to obtain a file that is not included in the trimmed search results.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

The following numbered clauses provide an overview of aspects of the present disclosure:

Clause 1. A computing system comprising: a memory storing computer-executable instructions; and one or more processors, individually or in combination, configured to execute the instructions, wherein the one or more processors are configured to: obtain a designation of a property associated with a site as protected from organization wide searches, the site being owned by an organization and including multiple files, the property being separate from a user access permission; receive a search request indicating an organization wide search from an artificial intelligence agent; perform a search according to the search request across an index of organization files; trim search results to exclude files within one or more sites having the property; and return the trimmed search results to the artificial intelligence agent.

Clause 2. The computing system of clause 1, wherein the one or more processors, individually or in combination, are further configured to: propagate the property associated with the site to a record for each file within the site in the index of organization files prior to performing the search.

Clause 3. The computing system of clause 1 or 2, wherein the one or more processors, individually or in combination, are further configured to: set the property associated with the site in a store of the site and multiple files, wherein trimming the search results comprises: querying the property for the search results from the store; and filtering the search results based on a query result from the store.

Clause 4. The computing system of any of clauses 1-3, wherein the one or more processors, individually or in combination, are further configured to apply the trimmed search results to a large language model.

Clause 5. The computing system of any of clauses 1-4, wherein the one or more processors, individually or in combination, are further configured to allow a user having a user access permission to access the site including the excluded files outside of the organization wide search.

Clause 6. The computing system of any of clauses 1-5, wherein to trim the search results to exclude files within one or more sites having the property, the one or more processors, individually or in combination, are further configured to include a search result within one or more sites having the property when a user associated with the search has accessed the search result within a threshold period of time.

Clause 7. The computing system of any of clauses 1-6, wherein the one or more processors, individually or in combination, are further configured to generate an audit event in response to the property associated with the site being enabled or disabled.

Clause 8. A method of protecting content during a search: obtain a designation of a property associated with a site as protected from organization wide searches, the site being owned by an organization and including multiple files, the property being separate from a user access permission; receiving a search request indicating an organization wide search from an artificial intelligence agent; performing a search according to the search request across an index of organization files; trimming search results to exclude files within one or more sites having the property; and returning the trimmed search results to the artificial intelligence agent.

Clause 9. The method of clause 8, further comprising: propagating the property associated with the site to a record for each file within the site in the index of organization files prior to performing the search.

Clause 10. The method of clause 8 or 9, further comprising: setting the property associated with the site in a store of the site and multiple files, wherein trimming the search results comprises: querying the property for the search results from the store; and filtering the search results based on a query result from the store.

Clause 11. The method of any of clauses 8-10, further comprising applying the trimmed search results to a large language model.

Clause 12. The method of any of clauses 8-11, further comprising allowing a user having a user access permission to access the site including the excluded files outside of the organization wide search.

Clause 13. The method of any of clauses 8-12, wherein trimming search results to exclude files within one or more sites having the property comprises including a search result within one or more sites having the property when a user associated with the search has accessed the search result within a threshold period of time.

Clause 14. The method of any of clauses 8-13, further comprising generating an audit event in response to the property associated with the site being enabled or disabled.

Clause 15. A non-transitory computer-readable medium storing computer-executable instructions, that when executed cause a processor to: obtain a designation of a property associated with a site as protected from organization wide searches, the site being owned by an organization and including multiple files, the property being separate from a user access permission; receive a search request indicating an organization wide search from an artificial intelligence agent on behalf of a user; perform a search according to the search request across an index of organization files; trim search results to exclude files within one or more sites having the property; return the trimmed search results to the artificial intelligence agent; and allow the user having the user access permission to access the site including the excluded files outside of the organization wide search.

Clause 16. The non-transitory computer-readable medium of clause 15, wherein the computer-executable instructions, when executed, cause the processor to: propagate the property associated with the site to a record for each file within the site in the index of organization files prior to performing the search.

Clause 17. The non-transitory computer-readable medium of clause 15 or 16, wherein the computer-executable instructions, when executed, cause the processor to: set the property associated with the site in a store of the site and multiple files, wherein trimming the search results comprises: querying the property for the search results from the store; and filtering the search results based on a query result from the store.

Clause 18. The non-transitory computer-readable medium of any of clauses 15-17, wherein the computer-executable instructions, when executed, cause the processor to: apply the trimmed search results to a large language model.

Clause 19. The non-transitory computer-readable medium of any of clauses 15-18, wherein the computer-executable instructions, when executed, cause the processor to include a search result within one or more sites having the property when a user associated with the search has accessed the search result within a threshold period of time.

Clause 20. The non-transitory computer-readable medium of any of clauses 15-19, wherein the computer-executable instructions, when executed, cause the processor to generate an audit event in response to the property associated with the site being enabled or disabled.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computing system comprising:
a memory storing computer-executable instructions; and
one or more processors, individually or in combination, configured to execute the instructions, wherein the one or more processors are configured to:
obtain a designation of a property associated with a site as protected from organization wide searches, the site being owned by an organization and including multiple files, the property being separate from a user access permission;
receive a search request indicating an organization wide search from an artificial intelligence agent;
perform a search according to the search request across an index of organization files;
trim search results to exclude files within one or more sites having the property; and
return the trimmed search results to the artificial intelligence agent.

2. The computing system of claim 1, wherein the one or more processors, individually or in combination, are further configured to:
propagate the property associated with the site to a record for each file within the site in the index of organization files prior to performing the search.

3. The computing system of claim 1, wherein the one or more processors, individually or in combination, are further configured to:
set the property associated with the site in a store of the site and multiple files, wherein trimming the search results comprises:
querying the property for the search results from the store; and
filtering the search results based on a query result from the store.

4. The computing system of claim 1, wherein the one or more processors, individually or in combination, are further configured to apply the trimmed search results to a large language model.

5. The computing system of claim 1, wherein the one or more processors, individually or in combination, are further configured to allow a user having a user access permission to access the site including the excluded files outside of the organization wide search.

6. The computing system of claim 1, wherein to trim the search results to exclude files within one or more sites having the property, the one or more processors, individually or in combination, are further configured to include a search result within one or more sites having the property when a user associated with the search has accessed the search result within a threshold period of time.

7. The computing system of claim 1, wherein the one or more processors, individually or in combination, are further configured to generate an audit event in response to the property associated with the site being enabled or disabled.

8. A method of protecting content during a search:
obtain a designation of a property associated with a site as protected from organization wide searches, the site being owned by an organization and including multiple files, the property being separate from a user access permission;
receiving a search request indicating an organization wide search from an artificial intelligence agent;
performing a search according to the search request across an index of organization files;
trimming search results to exclude files within one or more sites having the property; and
returning the trimmed search results to the artificial intelligence agent.

9. The method of claim 8, further comprising:
propagating the property associated with the site to a record for each file within the site in the index of organization files prior to performing the search.

10. The method of claim 8, further comprising:
setting the property associated with the site in a store of the site and multiple files, wherein trimming the search results comprises:
querying the property for the search results from the store; and
filtering the search results based on a query result from the store.

11. The method of claim 8, further comprising applying the trimmed search results to a large language model.

12. The method of claim 8, further comprising allowing a user having a user access permission to access the site including the excluded files outside of the organization wide search.

13. The method of claim 8, wherein trimming search results to exclude files within one or more sites having the property comprises including a search result within one or more sites having the property when a user associated with the search has accessed the search result within a threshold period of time.

14. The method of claim 8, further comprising generating an audit event in response to the property associated with the site being enabled or disabled.

15. A non-transitory computer-readable medium storing computer-executable instructions, that when executed cause a processor to:
obtain a designation of a property associated with a site as protected from organization wide searches, the site being owned by an organization and including multiple files, the property being separate from a user access permission;
receive a search request indicating an organization wide search from an artificial intelligence agent on behalf of a user;
perform a search according to the search request across an index of organization files;
trim search results to exclude files within one or more sites having the property;
return the trimmed search results to the artificial intelligence agent; and
allow the user having the user access permission to access the site including the excluded files outside of the organization wide search.

16. The non-transitory computer-readable medium of claim 15, wherein the computer-executable instructions, when executed, cause the processor to:
propagate the property associated with the site to a record for each file within the site in the index of organization files prior to performing the search.

17. The non-transitory computer-readable medium of claim 15, wherein the computer-executable instructions, when executed, cause the processor to:
set the property associated with the site in a store of the site and multiple files, wherein trimming the search results comprises:
querying the property for the search results from the store; and
filtering the search results based on a query result from the store.

18. The non-transitory computer-readable medium of claim 15, wherein the computer-executable instructions, when executed, cause the processor to:
apply the trimmed search results to a large language model.

19. The non-transitory computer-readable medium of claim 15, wherein the computer-executable instructions, when executed, cause the processor to include a search result within one or more sites having the property when a user associated with the search has accessed the search result within a threshold period of time.

20. The non-transitory computer-readable medium of claim 15, wherein the computer-executable instructions, when executed, cause the processor to generate an audit event in response to the property associated with the site being enabled or disabled.
